(19) United States
(12) Patent Application Publication
(10) Pub. No.: US 2026/0109064 A1
(43) Pub. Date: Apr. 23, 2026

(54) HAIR COLLECTOR FOR A HAIR CUTTING APPLIANCE HAVING A CUTTING ELEMENT

(71) Applicant: KONINKLIJKE PHILIPS N.V., EINDHOVEN (NL)

(72) Inventors: GIJSBERT HENDRIK VAN VELDHUIZEN, GRONINGEN (NL); ALBERT AL-SHORACHI, ZWOLLE (NL); NOEMIE CLAIRE MATHILDE LEVE, BEAUCAMPS-LIGNY (FR)

(21) Appl. No.: 19/361,707

(22) Filed: Oct. 17, 2025

Related U.S. Application Data
(63) Continuation of application No. 17/286,504.

(30) Foreign Application Priority Data
Dec. 12, 2018 (EP) 18211887.7

(51) Int. Cl. B26B 19/38; B26B 19/04; B26B 19/42

(52) U.S. Cl. CPC B26B 19/3813; B26B 19/42; B26B 19/04

(57) ABSTRACT

A hair collector for a hair cutting appliance having a high frequency oscillating planar blade includes a housing and an attachment portion to attach the hair collector to the hair cutting appliance. Side walls of the housing have teeth that define openings and taper form an outer surface to an inner surface of the side wall, enabling hairs including long hairs to enter the system and be cut and held within a hair collection chamber formed by the side walls and the planar blade. The hair collection chamber defines a volume sufficient to contain substantially all sprayed cut hair particles produced during grooming as a result of the oscillating frequency of the planar blade.

### CROSS REFERENCE TO RELATED APPLICATION

The present application is a continuation of co-pending U.S. patent application Ser. No. 17/286,504, filed Apr. 19, 2021, which is the U.S. National Phase application under 35 U.S. C. § 371 of International Application No. PCT/EP2019/084777 filed Dec. 12, 2019, which claims the benefit of European Application No. 18211887.7 filed Dec. 12, 2018. These applications are hereby incorporated by reference herein.

### FIELD OF THE INVENTION

The present invention relates to hair collector for a hair cutting appliance having a cutting element, a hybrid hair cutting appliance having a cutting element and a razor guard to which is connected a hair collector, a hybrid hair cutting appliance having a cutting element and a razor guard to which is integrated a hair collector, and a method of collecting hair from a hair cutting appliance having a cutting element.

### BACKGROUND OF THE INVENTION

Hair cutting appliances are used to cut human hair, during trimming and shaving. Some hair cutting appliances can provide both shaving and trimming functionality, and as such can be termed hybrid cutting systems. Such a hair cutting appliance, which can be a hybrid hair cutting appliance, can have a cutting element that operates at very high frequencies and that consequently reaches high velocities. A moveable cutting element or cutter can reciprocates at high frequencies of the order of 7000 oscillations per second. Due to this high cutting frequency, the energy transmitted to the hair during the cutting action can be high, leading to high velocities being imparted to the hair and a significant spray of cut hair particles. This spray can then litter the environment within which the grooming takes place.

There is a need to address this issue.

Patent application DE 197 27 095 A1 discloses an electrical shaver which shaving unit comprises a foil shaver which is located next to hair righting elements. Between these hair righting elements and the foil shaver an opening appears to be present.

Patent application US 2006/174487 A1 discloses a hair trimmer with an ion emitter assembly. The application discloses a comb attachment to be coupled to the cutting end of the hair trimmer such that the blade set of the trimmer is disposed within the comb. The comb attachment according to this patent application allegedly defines a cavity for receiving trimmed hairs as the blade set cuts a person's hair.

### SUMMARY OF THE INVENTION

It would be advantageous to have improved means for mitigating the spray of cut hair particles from hair cutting appliances such as hybrid hair cutting appliances.

The object of the present invention is solved with the subject matter of the independent claims, wherein further embodiments are incorporated in the dependent claims. It should be noted that the following described aspects and examples of the invention apply also to the hair collector for a hair cutting appliance having a cutting element, the hybrid hair cutting appliance having a cutting element and a razor guard to which is connected a hair collector, the hybrid hair cutting appliance having a cutting element and a razor guard to which is integrated a hair collector, and the method of collecting hair from a hair cutting appliance having a cutting element.

According to a first aspect, there is provided a hair collector for a hair cutting appliance having a cutting element, the hair collector comprising:
a housing; and
an attachment portion.

The housing comprises a plurality of walls. The attachment portion is configured to attach the hair collector to the hair cutting appliance. When the hair collector is connected to the hair cutting appliance, a cut hair collection chamber is formed. The cut hair collection chamber comprises the plurality of walls of the housing and the cutting element. When the hair collector is connected to the hair cutting appliance, the hair collector is configured such that the cutting element can contact skin of a user of the hair cutting appliance.

In this manner, a hair collector is provided that can enclose a cutting element of a hair cutting appliance, such as a hybrid shaver/trimmer or other device operating with a reciprocating/trimmer style, to form a closed compartment along with the cutting element to collect cut off hair.

In this way hair cut with a hair cutting appliance that can cut facial and body hair and trim, that operates with a rapidly oscillating or high frequency cutting element, can be collected that otherwise can be uncontrollably sprayed.

Thus, the hair collector operates in conjunction with the cutting element to form a compartment for collecting cut hair, but does not interfere with the cutting element and any associated hair lifting facility associated with the cutting element, such as that provided by a guard.

In an example, at least one side wall of the plurality of walls of the housing comprises a structure forming a plurality of openings.

In an example, when the hair collector is connected to the hair cutting appliance the structure is configured to enable hair to pass through the plurality of openings to enter the cut hair collection chamber.

In other words, a semi open filtering system is provided, enabling hair to enter the hair collector and be cut, but where the system blocks hair from leaving the hair collector after it is cut.

In an example, the structure is configured to inhibit hair to pass through the plurality of openings to exit the cut hair collection chamber.

In this manner, the structure functions as a funnel, making it easier for hair to travel in and be cut but harder for hair to travel out.

Thus, in other words a structure of the hair collector wall, or walls, that can be teeth of a comb like element are shaped such that when seen in a hair travelling direction towards the cutting direction they guide hairs, and when seen in the opposite direction they block hairs. This can be for example through having a triangular shape with the apex (that can be rounded) pointing away from the cutting element.

In an example, a total surface area of the structure at an outer surface of the at least one side wall is less than a total surface of the structure at an inner surface of the at least one side wall.

In other words, openings in walls of the hair collector are tapered to enable hair to enter, but not to exit when it has been cut off.

In this way hair orientation can be gradually influenced, whilst at the same time uncut hair can enter the collection chamber, and be cut, and can then not exit the chamber.

To put this another way, there is a slotted wall with teeth, which has a larger open outer surface area compared to the open inner surface area. In other words, the shaper edge of the teeth point outwards.

In an example, the structure comprises a comb like structure with a plurality of teeth. The teeth taper from an outer surface of the at least one side wall to an inner surface of the at least one side wall.

Thus, the teeth being tapered enable hair to enter the hair collector and be cut, but then hair that is cut cannot exit. However, because the hair collector does not inhibit the cutting element from contacting the skin, the lifting and cutting performance of a hair cutting appliance such as a hybrid razor to which the hair collector is connected is not affected, because the teeth do not act at skin level but are positioned above the cutting element.

In an example, an angle of taper of the teeth is constant.

In this manner, by having a constant angle hair is moved through the structure from entry to exit into the hair collection chamber with a continuous counter force on the moving hair.

In an example, the teeth have a triangular cross-section.

In an example, the plurality of openings extend in a longitudinal direction of the at least one side wall. When the hair collector is connected to the hair cutting appliance the longitudinal direction is perpendicular to a plane of the cutting element.

In this manner, hair can be vertically aligned with respect to the skin in a lateral direction with respect to a forward motion of the hair collector connected to the hair cutting appliance. Hair of different lengths, for example of beards, can then enter the hair collector.

To put this another way, a cut hair collection space is provided around a cutting element of a hair cutting appliance such as a hybrid hair cutting system by placing a comb like element, the hair collector, over the cutting element, between a main housing of the hair cutting element and the cutting element. The cutting element can touch the skin and the comb like element is spaced above the skin and need not touch the skin, providing for optimal hair catching from hair that is cut and allowing hair that can be long to easily move through openings and be cut.

In an example, a spatial period of the plurality of openings is configured to be an integer number of a spatial period of a plurality of openings of a razor guard of the cutting element.

In an example, a first side wall and a second side wall of the plurality of walls each comprises the structure. The first side wall is on an opposite side of the housing to the second side wall.

Thus, a double sided hair collector is provided that can then be fitted to a hair cutting appliance that has a cutting element that can cut in both forward and backward directions.

In an example, when the hair collector is connected to the hair cutting appliance at least two side walls of the plurality of walls define an outer plane at an outer extent of the hair collector. The hair collector is configured such that when the cutting element contacts the skin of the user the outer plane of the hair collector is located above a plane of the cutting element adjacent to the skin of the user.

According to a second aspect, there is provided a hybrid hair cutting appliance having a cutting element and a razor guard. The hybrid hair cutting appliance is configured for both shaving and trimming, and to which is connected a hair collector according to the first aspect.

According to a third aspect, there is provided a hybrid hair cutting appliance having a cutting element and a razor guard. The hybrid hair cutting appliance is configured for both shaving and trimming, and to which is integrated a hair collector. The hair collector comprises a housing. The housing comprises a plurality of walls. A cut hair collection chamber is formed comprising the plurality of walls of the housing and the cutting element. The hair collector is configured such that the cutting element can contact skin of a user of the hair cutting appliance.

According to a fourth aspect, there is provided method of collecting hair from a hair cutting appliance having a cutting element. The method comprises connecting a hair collector to the hair cutting appliance. The hair collector comprises:
a housing; and
an attachment portion.

The housing comprises a plurality of walls. The attachment portion attaches the hair collector to the hair cutting appliance. The collection of cut hair is provided via formation of a cut hair collection chamber. The cut hair collection chamber comprises the plurality of walls of the housing and the cutting element. The hair collector is configured such that the cutting element can contact skin of a user of the hair cutting appliance.

Advantageously, the benefits provided by any of the above aspects equally apply to all of the other aspects and vice versa.

The above aspects and examples will become apparent from and be elucidated with reference to the embodiments described hereinafter.

### BRIEF DESCRIPTION OF THE DRAWINGS

Exemplary embodiments will be described in the following with reference to the following drawings:

FIG. 1 shows a schematic set up of an example of a hair collector for a hair cutting appliance with a schematic set up of an example of a hair cutting appliance also being shown;

FIG. 2 shows a schematic set up of an example of a hair cutting appliance having a hair collector;

FIG. 3 shows at the bottom a double cross section 3D view of a hair collector mounted over a cutting element and its driving system (cutting assembly) and shows at the top a front and bottom view of the same;

FIG. 4 shows the hair collector as shown in FIG. 3 being positioned over the cutting assembly;

FIG. 5 shows an open model of the hair collector positioned over the cutting assembly;

FIG. 6 shows an example of a hair cutting appliance with a cutting element, which has a hair collector, and where the hair cutting appliance is cutting hair;

FIG. 7 shows a schematic plan view of hair moving through a wall of a hair collector;

FIG. 8 shows a plan view of an exemplar the alignment of spacings of a hair collector at the top with spacings of a razor guard at the bottom, with an exemplar cutting element also shown; and

FIG. 9 shows a schematic example of the relative alignment of a hair collector with cutting element and razor guard with respect to skin of a user.

### DETAILED DESCRIPTION OF THE EMBODIMENTS

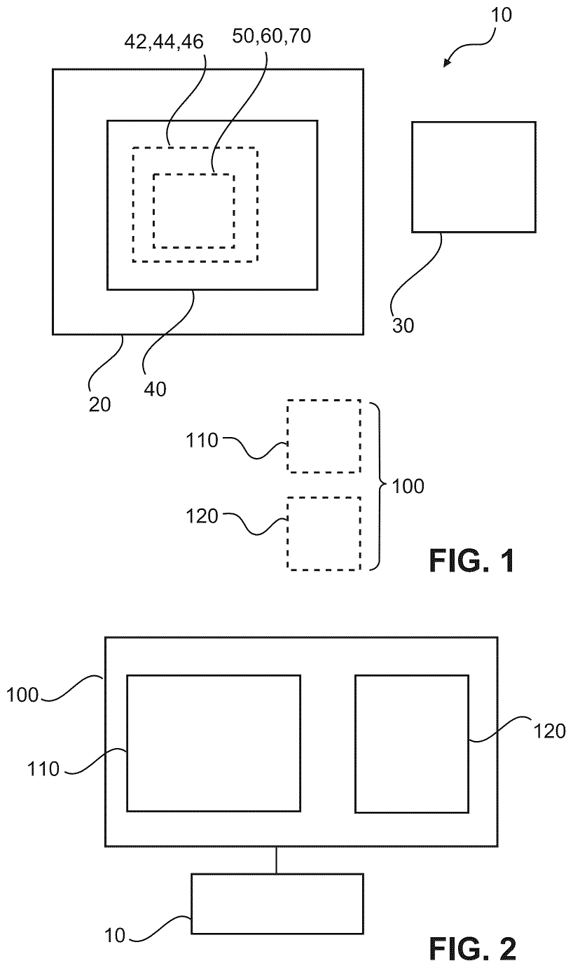

FIG. 1 shows an example of a hair collector 10 for a hair cutting appliance 100 having a cutting element 110. Essential elements are shown schematically in solid lines and optional elements are shown in dashed lines. FIG. 1 relates to the hair collector 10; however, for representation and context purposes the hair cutting appliance 100 is also shown.

Continuing with FIG. 1 the hair collector comprises a housing 20, and an attachment portion 30. The housing comprises a plurality of walls 40. The attachment portion is configured to attach the hair collector to the hair cutting appliance. When the hair collector is connected to the hair cutting appliance, a cut hair collection chamber is formed. The cut hair collection chamber comprises the plurality of walls of the housing and the cutting element. When the hair collector is connected to the hair cutting appliance, the hair collector is configured such that the cutting element can contact skin of a user of the hair cutting appliance.

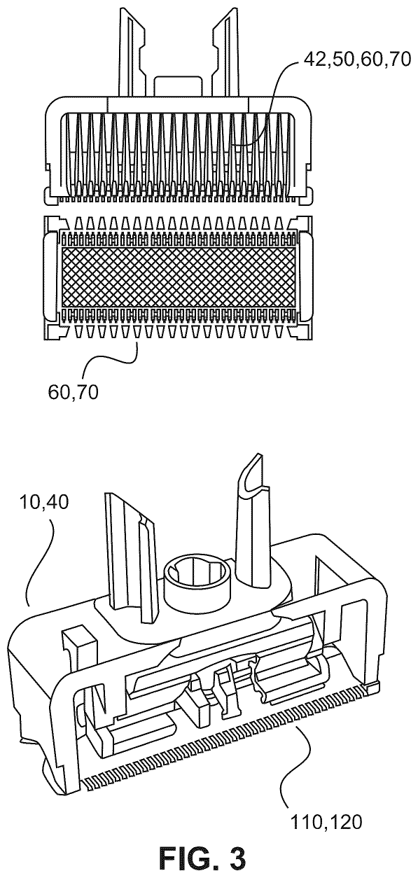

In an example, when the hair collector is connected to the hair cutting appliance, a drive system for the cutting element is located at least partially within the cut hair collection chamber. Thus a hair collecting space is provided locally, by attaching a reservoir directly to the cutting element, where the reservoir or collecting chamber encapsulates the blade including the driving system of the blade (driving bridge plus ex-center) thereby ensuring that cut hair that otherwise can be sprayed about due to high frequency oscillating parts is contained. This is further shown in detail in FIGS. 3-6.

In an example, the attachment portion is configured to attach the hair collector to the cutting element. The attachment portion can operate in a number of different ways, as would be appreciated by the skilled person. A further example of the attachment portion is shown in detail in FIGS. 3-5.

In an example, the attachment portion is configured to attach the hair collector to the hair cutting appliance in a releasable manner.

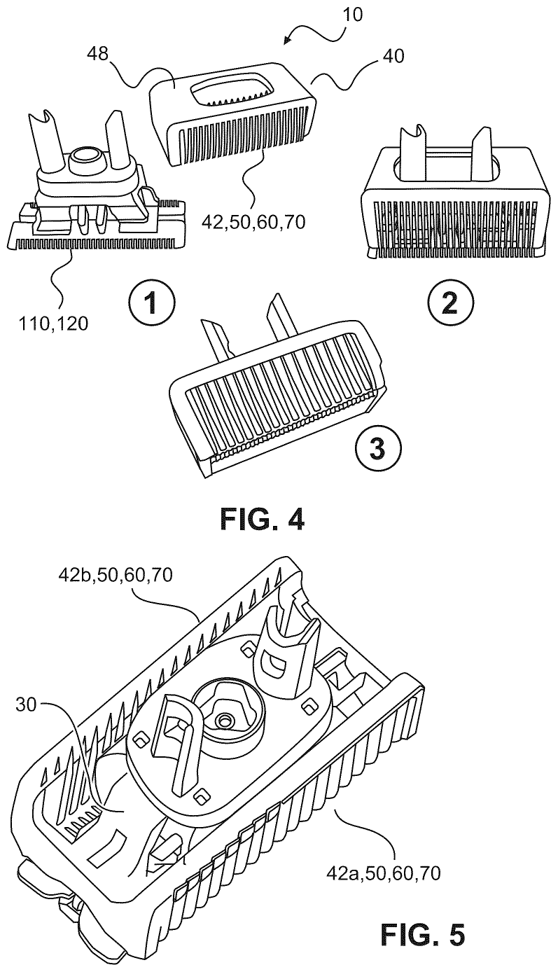

In an example, a wall 48 of the plurality of walls comprises an opening through which a connection part of a cutting assembly of the hair cutting appliance can be inserted. The cutting assembly comprises the cutting element. In this way, the hair collector can be placed over the cutting element and then connected to the hair cutting appliance, with this being shown in FIG. 4 enabling the hair collector to be placed over the cutting assembly.

In an example, the hair cutting appliance has a main housing, and wherein when the hair collector is connected to the hair cutting appliance the hair collector is located at least partially around the cutting element between the cutting element and the main housing. This hair collector around the cutting assembly and cutting element is shown in further detail in FIGS. 3-6.

In an example, the hair cutting appliance is a hybrid hair cutting appliance, configured for both shaving and trimming.

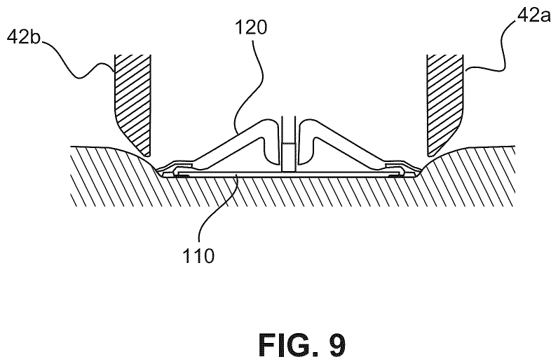

In an example, when the hair collector is connected to the hair cutting appliance, the hair collector is configured such that the cutting element can contact skin of the user of the hair cutting appliance and at the same time the hair collector does not touch the skin of the user. In this way, the hair lifting and guiding function of a guard of the cutting element is not affected, whilst at the same time hair collection of cut hairs that would otherwise be sprayed around is enabled. This is shown in further detail in FIG. 9.

In an example, when the hair collector is connected to the hair cutting appliance, the hair collector is configured such that the cutting element can contact skin of the user of the hair cutting appliance and at the same time the hair collector touches the skin of the user. In an example, the skin is contacted just above the level of the cutting element in front of the razor guard. In this way, maximum collection of cut hairs that would otherwise be sprayed around is enabled and at the same time an improved comfort feeling to the user is provided.

According to an example, at least one side wall 42 of the plurality of walls of the housing comprises a structure 50 forming a plurality of openings. Further detailed examples are shown in FIGS. 3-6.

In an example, the structure is configured to enable hair to pass through the plurality of openings to enter the cut hair collection chamber. A schematic exemplar of a detailed embodiment is shown in FIG. 8.

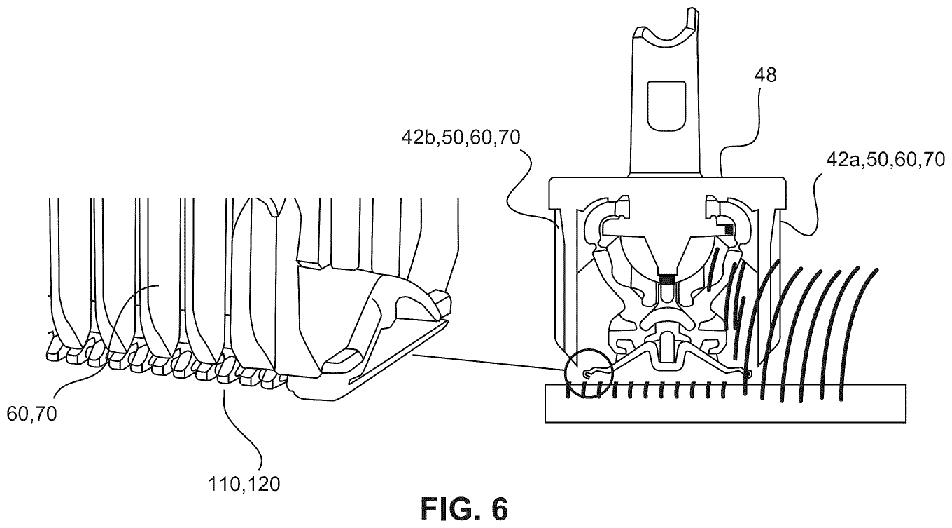

According to an example, when the hair collector is connected to the hair cutting appliance the structure is configured to enable hair to pass through the plurality of openings to enter the cut hair collection chamber. A representative detailed example is shown in FIG. 6.

In an example, the hair that can pass through the plurality of openings is uncut hair that is then cut by the cutting element.

According to an example, the structure is configured to inhibit hair to pass through the plurality of openings to exit the cut hair collection chamber.

According to an example, a total surface area of the structure at an outer surface 44 of the at least one side wall is less than a total surface of the structure at an inner surface 46 of the at least one side wall. This is further shown for example in the detailed embodiment of FIG. 8.

According to an example, the structure comprises a comb like structure 60 with a plurality of teeth 70. The teeth taper from an outer surface 44 of the at least one side wall to an inner surface 46 of the at least one side wall. This is further shown in the detailed examples of FIGS. 3-6 and 8.

According to an example, an angle of taper of the teeth is constant.

In an example, the angle of taper varies in going from the outer surface to the inner surface. Thus, the side walls of the teeth need not be flat, and can be curved and/or curved with flat regions. In an example, the side walls of the teeth can be concave or convex or be convex and concave and have be wavy shaped with both convex and concave regions.

According to an example, the teeth have a triangular cross-section.

In an example, the triangular teeth have a rounded apex.

Thus, there is a possibly rounded apex at an outer wall, with an inner wall surface that is relatively larger.

According to an example, the plurality of openings extend in a longitudinal direction of the at least one side wall. When the hair collector is connected to the hair cutting appliance the longitudinal direction is perpendicular to a plane of the cutting element. This is further shown in the detailed examples of FIGS. 3-6 and 9.

In an example, the plurality of openings extend linearly in the longitudinal direction, or in other words are straight. In an example, the plurality of openings extend in the longitudinal direction in a non-straight manner, and thus are not linear but are curved, whilst extending in the longitudinal direction. Thus, in an example the openings can have a wavy shape, that extend in the longitudinal direction.

According to an example, a spatial period of the plurality of openings is configured to be an integer number of a spatial period of a plurality of openings of a razor guard 120 of the cutting element. A specific further example is shown in FIG. 8.

In an example, teeth of the structure are pitched to a one to two ratio with respect to teeth of the razor guard. Other ratios are possible, such as one to one, one to three, and one to four.

In an example, when the hair collector is connected to the hair cutting appliance the plurality of the openings of the structure are configured to be aligned with an equivalent number of openings of the plurality of openings of the razor guard.

According to an example, a first side wall 42a and a second side wall 42b of the plurality of walls each comprises the structure. The first side wall is on an opposite side of the housing to the second side wall. A further detailed example is shown in FIGS. 5, 6 and 9.

In an example, the hair collector is symmetric with respect to 180 degree rotation about a centre axis.

Thus, ease of alignment for connection to both double sided and single sided cutting appliances is provided and at the same time manufacturing costs are reduced.

According to an example, when the hair collector is connected to the hair cutting appliance at least two side walls of the plurality of walls define an outer plane at an outer extent of the hair collector. The hair collector is configured such that when the cutting element contacts the skin of the user the outer plane of the hair collector is located above a plane of the cutting element adjacent to the skin of the user. Further detailed examples are shown in FIGS. 6 and 9.

In an example, the edges of the hair collector can be 1 mm above skin level when the cutting element is in contact with the skin. Other spacing distances can be utilized, such as 0.5 mm, 0.75 mm, 1.25 mm, 1.5 mm, 1.75 mm, and 2 mm. In an example, the edges of the hair collector are just above skin level of the user and just in front of the razor guard.

In an example, when the hair collector is connected to the hair cutting appliance the outer plane of the hair collector is substantially parallel to the plane of the cutting element.

FIG. 2 relates to an example of a hybrid hair cutting appliance 100 having a cutting element 110 and a razor guard 120. The hybrid hair cutting appliance is configured for both shaving and trimming. A hair collector 10 as described with respect to FIG. 1 is connected to the hybrid hair cutting appliance.

In an example, the hair cutting appliance is configured to enable disconnection of the hair collector.

The connection of the hair collector 10 to the hybrid hair cutting appliance can however be permanent. Therefore, FIG. 2 also relates to an example of a hybrid hair cutting appliance 100 having a cutting element 110 and a razor guard 120. The hybrid hair cutting appliance is configured for both shaving and trimming. Integrated to the hybrid hair cutting appliance is a hair collector 10a. The hair collector comprises a housing 20 comprising a plurality of walls 40. A cut hair collection chamber is formed, comprising the plurality of walls of the housing and the cutting element. The hair collector is configured such that the cutting element can contact skin of a user of the hair cutting appliance. Reference to hair collector 10a refers to a hair collector that is integrated with the hair cutting appliance, and has not been specifically shown to in FIG. 2, but has the same features as hair collector 10 except that it is not able to be disconnected from the hair cutting appliance.

In an example, a drive system for the cutting element is located at least partially within the cut hair collection chamber.

In an example, the hair cutting appliance has a main housing. The hair collector is located at least partially around the cutting element between the cutting element and the main housing.

In an example, the hair collector is configured such that the cutting element can contact skin of the user of the hair cutting appliance and at the same time the hair collector does not touch the skin of the user.

In an example, the hair collector is configured such that the cutting element can contact skin of the user of the hair cutting appliance and at the same time the hair collector touches the skin of the user. In an example, the skin is contacted just above the level of the cutting element in front of the razor guard.

In an example, at least one side wall 42 of the plurality of walls of the housing comprises a structure 50 forming a plurality of openings.

In an example, the structure is configured to enable hair to pass through the plurality of openings to enter the cut hair collection chamber.

In an example, the structure is configured to enable hair to pass through the plurality of openings to enter the cut hair collection chamber.

In an example, the hair that can pass through the plurality of openings is uncut hair that is then cut by the cutting element.

In an example, the structure is configured to inhibit hair to pass through the plurality of openings to exit the cut hair collection chamber.

In an example, a total surface area of the structure at an outer surface 44 of the at least one side wall is less than a total surface of the structure at an inner surface 46 of the at least one side wall.

In an example, the structure comprises a comb like structure 60 with a plurality of teeth 70. The teeth taper from an outer surface 44 of the at least one side wall to an inner surface 46 of the at least one side wall.

In an example, an angle of taper of the teeth is constant.

In an example, the teeth have a triangular cross-section.

In an example, the triangular teeth have a rounded apex.

In an example, the plurality of openings extend in a longitudinal direction of the at least one side wall. The longitudinal direction is perpendicular to a plane of the cutting element.

In an example, a spatial period of the plurality of openings is configured to be an integer number of a spatial period of a plurality of openings of a razor guard 120 of the cutting element.

In an example, teeth of the structure are pitched to a one to two ratio with respect to teeth of the razor guard.

In an example, the plurality of the openings of the structure are configured to be aligned with an equivalent number of openings of the plurality of openings of the razor guard.

In an example, a first side wall 42a and a second side wall 42b of the plurality of walls each comprises the structure. The first side wall is on an opposite side of the housing to the second side wall.

In an example, the hair collector is symmetric with respect to 180 degree rotation about a centre axis.

In an example, at least two side walls of the plurality of walls define an outer plane at an outer extent of the hair collector. The hair collector is configured such that when the cutting element contacts the skin of the user the outer plane of the hair collector is located above a plane of the cutting element adjacent to the skin of the user.

In an example, the edges of the hair collector can be 1 mm above skin level when the cutting element is in contact with the skin. Other spacing distances can be utilized, such as 0.5 mm, 0.75 mm, 1.25 mm, 1.5 mm, 1.75 mm, and 2 mm. In an example, the edges of the hair collector are just above skin level of the user and just in front of the razor guard.

In an example, when the hair collector is connected to the hair cutting appliance the outer plane of the hair collector is substantially parallel to the plane of the cutting element.

The figures also relate to a method of collecting hair from a hair cutting appliance 100 having a cutting element 110. The method comprises connecting a hair collector 10 to the hair cutting appliance. The hair collector comprises a housing 20 and an attachment portion 30. The housing comprises a plurality of walls 40. The attachment portion attaches the hair collector to the hair cutting appliance. The collection of cut hair is provided via formation of a cut hair collection chamber. The cut hair collection chamber comprises the plurality of walls of the housing and the cutting element. The hair collector is configured such that the cutting element can contact skin of a user of the hair cutting appliance.

In an example, a drive system for the cutting element is located at least partially within the cut hair collection chamber.

In an example, the attachment portion attaches the hair collector to the cutting element.

In an example, the attachment portion attaches the hair collector to the hair cutting appliance in a releasable manner.

In an example, a wall 48 of the plurality of walls comprises an opening through which a connection part of a cutting assembly of the hair cutting appliance can be inserted. The cutting assembly comprises the cutting element.

In an example, the hair cutting appliance has a main housing. The hair collector is located at least partially around the cutting element between the cutting element and the main housing.

In an example, the hair cutting appliance is a hybrid hair cutting appliance, configured for both shaving and trimming.

In an example, the cutting element can contact skin of the user of the hair cutting appliance and at the same time the hair collector does not touch the skin of the user.

In an example, the cutting element can contact skin of the user of the hair cutting appliance and at the same time the hair collector touches the skin of the user. In an example, the skin is contacted just above the level of the cutting element in front of the razor guard.

In an example, at least one side wall 42 of the plurality of walls of the housing comprises a structure 50 forming a plurality of openings.

In an example, the structure enables hair to pass through the plurality of openings to enter the cut hair collection chamber.

In an example, the hair that can pass through the plurality of openings is uncut hair that is then cut by the cutting element.

In an example, the structure inhibits hair to pass through the plurality of openings to exit the cut hair collection chamber.

In an example, a total surface area of the structure at an outer surface 44 of the at least one side wall is less than a total surface of the structure at an inner surface 46 of the at least one side wall.

In an example, the structure comprises a comb like structure 60 with a plurality of teeth 70. The teeth taper from an outer surface 44 of the at least one side wall to an inner surface 46 of the at least one side wall.

In an example, an angle of taper of the teeth is constant.

In an example, the teeth have a triangular cross-section.

In an example, the plurality of openings extend in a longitudinal direction of the at least one side wall. The longitudinal direction is perpendicular to a plane of the cutting element.

In an example, a spatial period of the plurality of openings is configured to be an integer number of a spatial period of a plurality of openings of a razor guard 120 of the cutting element.

In an example, teeth of the structure are pitched to a one to two ratio with respect to teeth of the razor guard. Other ratios are possible, such as one to one, one to three, and one to four.

In an example, the plurality of the openings of the structure are aligned with an equivalent number of openings of the plurality of openings of the razor guard.

In an example, a first side wall 42a and a second side wall 42b of the plurality of walls each comprises the structure, and the first side wall is on an opposite side of the housing to the second side wall.

In an example, the hair collector is symmetric with respect to 180 degree rotation about a centre axis.

In an example, at least two side walls of the plurality of walls define an outer plane at an outer extent of the hair collector. The hair collector is configured such that when the cutting element contacts the skin of the user the outer plane of the hair collector is located above a plane of the cutting element adjacent to the skin of the user.

In an example, the edges of the hair collector can be 1 mm above skin level when the cutting element is in contact with the skin. Other spacing distances can be utilized, such as 0.5 mm, 0.75 mm, 1.25 mm, 1.5 mm, 1.75 mm, and 2 mm. In an example, the edges of the hair collector are just above skin level of the user and just in front of the razor guard.

In an example, when the hair collector is connected to the hair cutting appliance the outer plane of the hair collector is substantially parallel to the plane of the cutting element.

The hair collector for a hair cutting appliance having a cutting element, and hybrid hair cutting appliance with such a hair collector are now additionally described in conjunction with specific embodiments shown in FIGS. 3-9.

As shown in FIG. 3 a cut hair particle collection space or chamber is provided between a housing of a hybrid hair cutting appliance (both not shown) and a cutting element 110 of the hybrid hair cutting appliance. This is achieved by placing a (double sided) hair collector 10, with side walls 42 having a comb like structure 60 having a plurality of teeth 70, over the cutting element, as shown in image section 1, 2, and 3 of FIG. 3. The cut hair collection chamber is formed by walls 40 of the hair collector and the cutting element. The hair collector in this example does not touch the skin to allow optimal hair catching by the cutting element and allows (longer) hairs to easily move through the openings, and not affect the functioning of a razor guard 120. As further described along with FIG. 9, as the teeth of the hair collector do not act on the skin level and are positioned above the cutting element, the lifting and cutting performance of a hybrid cutting appliance is not affected. For the specific embodiment shown in FIG. 9, the teeth of the hair collector are 1 mm above skin level when the cutting element touches the skin, and are positioned just in front of a razor guard. In this way, the vast amount of cut hair is collected and is not sprayed, and the hair collector can be easily placed over the cutting assembly. However, in a specific embodiment the hair collector teeth can contact the skin and at the same time the cutting element touch the skin.

Continuing with FIG. 3 the hair collector forms a collection chamber with the cutting element, and is in effect a cap that provides a removable compartment for the collection of cut hairs. A fixation and alignment system enables the hair collector to be guided into position and locked onto the cutting assembly. The hair collector has a filtering inlet system, that enables hairs including long hairs to enter the system and be cut and held within the hair collection chamber formed. The teeth of opposing walls of the hair collector each are a comb like element that are shaped such that when seen in a hair travelling direction towards the cutting direction they guide hairs and when seen in the opposite direction they block hair debris. This is achieved for example by having a triangular shape of which the top or apex is pointing away from the cutting element.

As shown in FIG. 4, the hair collector can easily be positioned over the cutting assembly because the top wall 48 has an opening, and hair collector locks onto the cutting assembly. As shown in FIG. 5 a set of snap hooks enable the hair collector to be fixed to the cutting assembly, and as shown for example in FIG. 5 two opposing side walls 42a and 42b have the comb like structure 60 with teeth 70. The hair collector can be made by single part injection molding. Furthermore, as shown in FIG. 5, the hair collector can be in the form of a more open version, enabling the hair collector to operate with hair cutting appliances having for example a specific type of handle for which such an open version operates. However, this open version still provides a hair collection chamber from walls of the hair collector and the cutting element, and operates for certain types of hair cutting appliances, with for example different handles and a different contra geometry.

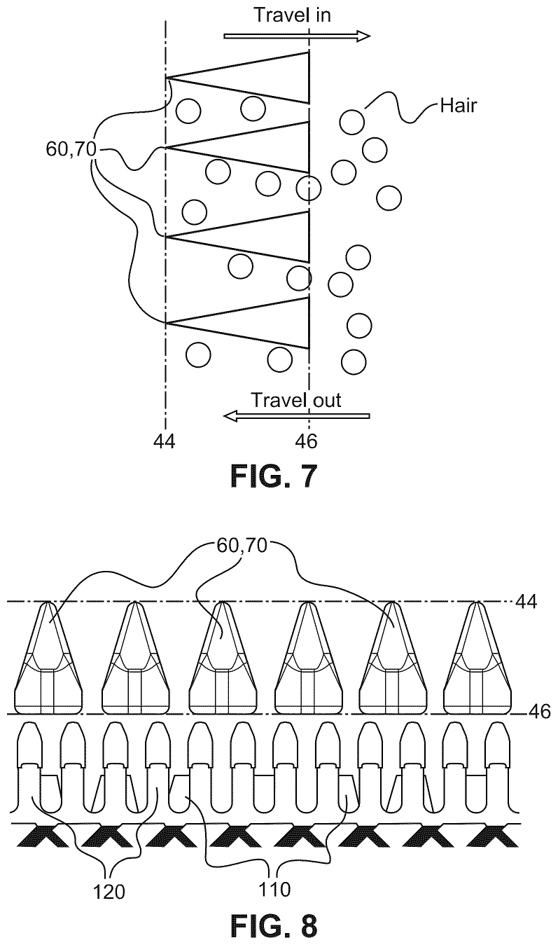

The hair filtering and collection system is shown in more detail in FIGS. 6 and 7. A semi open filtering system is provided that enables hair to enter a hair collection chamber through the hair filter system but blocks hair from leaving the chamber after it is cut. The walls of the hair collector are positioned just above the cutting element, where teeth of the comb structure of the walls do not interfere with the hair lifting ability of the razor guard. The size of the slots between the teeth is optimized to enable hair entry over the full frontal surface but largely block hairs from leaving the inner hair collection chamber. The teeth in the side walls of the hair collector function as a funnel, making it easy for hair to travel inwards but harder for hair to travel outwards. To optimize this effect, the outer (frontal) surface of the teeth is small and the inner (back) surface is large. The size and shape of the outer teeth surface is designed to function as described, but also is deigned in order to be compatible with injection molding manufacturing in this specific example, The size of the inner surface is designed with a view on entry performance, and the rate at which hairs can enter the system. The teeth are shaped in such a way that they gradually influence hair orientation. A fixed angle enables the hair to move towards the point of exit with a continuous counter force on the moving hair, but other shapes also have utility. The smaller the angle, the less hairs get pushed out of the system.

FIG. 8 shows a plan view of an exemplar geometry of the teeth of one side wall of the hair collector, where the teeth start at an outer plane 44 and become wider in extending to an inner plane 46. In this specific example, the teeth are pitched in a one to two ratio with teeth of a razor guard, but other ratios are possible.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments.

Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfill the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A hair collector for a hair cutting appliance, the hair cutting appliance having a planar blade that defines a skin contact surface, the hair collector comprising:
a housing; and
a hair collector attachment portion;
wherein, the housing comprises at least two side walls;
wherein the at least two side walls each comprise a plurality of teeth, the plurality of teeth forming a plurality of openings extending along a longitudinal direction of the plurality of teeth;
wherein, the hair collector attachment portion is configured to attach the hair collector to the hair cutting appliance;
wherein, when the hair collector is connected to the hair cutting appliance, at least two of the plurality of walls of the housing define an outer plane at an outer extent of the hair collector, a cut hair collection chamber is formed by the at least two side walls and the planar blade, the cut hair collection chamber defining a volume sufficient to collect a vast amount of cut hair particles produced while grooming; and
wherein, when the hair collector is connected to the hair cutting appliance, the hair collector is configured such that when the skin contact surface of the planar blade contacts a skin of a user of the hair cutting appliance, the outer plane of the hair collector is located above a plane defined by the skin contact surface of the planar blade such that the outer plane of the hair collector is on an opposite side of the plane of the skin contact surface as the skin of the user.

2. The hair collector according to claim 1, wherein the plurality of teeth taper from an outer surface of each of the at least two side walls to an inner surface of each of the at least two side walls such that the plurality of openings are larger at the outer surface of each of the at least two side walls than at the inner surface of each of the at least two side walls

3. The hair collector according to claim 1, wherein when the hair collector is connected to the hair cutting appliance, the plurality of teeth are configured to enable hair to pass through the plurality of openings to enter the cut hair collection chamber.

4. The hair collector according to claim 1, wherein a total surface area of the plurality of teeth at an outer surface of each of the at least two side walls is less than a total surface of the plurality of teeth at an inner surface of each of the at least two side walls.

5. The hair collector according to claim 2, wherein an angle of taper of the plurality of teeth is constant.

6. The hair collector according to claim 1, wherein each of the plurality of teeth has a triangular cross-section.

7. The hair collector according to claim 1, wherein when the hair collector is connected to the hair cutting appliance the longitudinal direction is perpendicular to a plane of the planar blade.

8. The hair collector according to claim 1, wherein a quantity of the plurality of openings is configured to be an integer ratio of a quantity of a plurality of openings of a razor guard of the cutting appliance.

9. The hair collector according to claim 1, wherein the at least two side walls comprise a first side wall and a second side wall and wherein the first side wall is on an opposite side of the housing to the second side wall.

10. The hair collector for a hair cutting appliance, the hair cutting appliance further having a driving system for driving the planar blade, according to claim 1, wherein the volume defined by the cut hair collection chamber at least partially encapsulates the driving system.

11. The hair collector according to claim 1, wherein the volume defined by the cut hair collection chamber encapsulates the planar blade.

12. The hair collector according to claim 1, wherein the outer plane of the hair collector is parallel to the plane of the blade.

13. The hair collector for a hair cutting appliance, the hair cutting appliance having a planar blade having a first cutting edge and a second cutting edge, according to claim 1, wherein each of the at least two side walls defines an outer edge and wherein, when the hair collector is connected to the hair cutting appliance, the outer edges of the at least two side walls are positioned one each parallel to the first and second cutting edges of the planar blade.

14. A hybrid hair cutting appliance having a blade and a razor guard, the razor guard configured for both shaving and trimming, to which is connected the hair collector according to claim 1.

15. A hybrid hair cutting appliance having a blade and a razor guard, configured for both shaving and trimming, to which is integrated a hair collector, wherein the hair collector comprises a housing comprising at least two side walls, wherein the at least two side walls each comprise a plurality of teeth, the plurality of teeth forming a plurality of openings extending along a longitudinal direction of the plurality of teeth, wherein the at least two side walls define an outer plane at an outer extent of the hair collector, wherein a cut hair collection chamber is formed, the cut hair collection chamber comprising the at least two side walls and the blade, the cut hair collection chamber defining a volume sufficient to collect a vast amount of cut hair particles produced while grooming, wherein the plurality of teeth taper from an outer surface of each of the at least two side walls to an inner surface of each of the at least two side walls such that the plurality of openings are larger at the outer surface of each of the at least two side walls than at the inner surface of each of the at least two side walls; and wherein the hair collector is configured such that when the blade contacts a skin of a user of the hair cutting appliance, the outer plane of the hair collector is located above a plane of the blade adjacent to the skin of the user, such that the outer plane of the hair collector is on an opposite side of the plane of the blade as the skin of the user.

16. A hair collector for a hair cutting appliance, the hair cutting appliance having a high frequency oscillating planar blade that reciprocates during operation at a frequency, for example, of approximately 7000 oscillations per second, the hair collector comprising:
a housing; and
a hair collector attachment portion;
wherein, the housing comprises at least two side walls;
wherein the at least two side walls each comprise a plurality of teeth, the plurality of teeth forming a plurality of openings extending along a longitudinal direction of the plurality of teeth;
wherein, the hair collector attachment portion is configured to attach the hair collector to the hair cutting appliance;
wherein, when the hair collector is connected to the hair cutting appliance, a cut hair collection chamber is formed by the at least two side walls and the planar blade, the cut hair collection chamber defining a volume sufficient to contain substantially all sprayed cut hair particles produced during grooming as a result of the oscillating frequency of the planar blade; and
wherein the plurality of teeth taper from an outer surface of each of the at least two side walls to an inner surface of each of the at least two side walls such that the plurality of openings are larger at the outer surface of each of the at least two side walls than at the inner surface of each of the at least two side walls.

17. The hair collector according to claim 16, wherein at least two of the plurality of walls of the housing define an outer plane at an outer extent of the hair collector, and
wherein, when the hair collector is connected to the hair cutting appliance, the hair collector is configured such that when the planar blade contacts a skin of a user of the hair cutting appliance, the outer plane of the hair collector is located above a plane of defined by the planar blade. such that the outer plane of the hair collector is on an opposite side of the plane of the planar blade as the skin of the user.

18. The hair collector for a hair cutting appliance, the hair cutting appliance further having a driving system for driving the blade, according to claim 16, wherein the volume defined by the cut hair collection chamber at least partially encapsulates the driving system.

19. The hair collector according to claim 16, wherein the volume defined by the cut hair collection chamber encapsulates the blade.

20. The hair collector according to claim 17, wherein the outer plane of the hair collector is parallel to the plane of the blade.
